(19) United States
(12) Patent Application Publication
(10) Pub. No.: US 2020/0314090 A1
(43) Pub. Date: Oct. 1, 2020

(54) SYSTEM FOR SECURELY SHARING CONTENT OVER A NETWORK USING PERSISTENT INDIVIDUAL SERVERS

(71) Applicant: Thomas Maurice DANTIN, JR., Ponte Vedra Beach, FL (US)

(72) Inventor: Thomas Maurice DANTIN, JR., Ponte Vedra Beach, FL (US)

(21) Appl. No.: 16/834,846

(22) Filed: Mar. 30, 2020

Related U.S. Application Data
(60) Provisional application No. 62/827,062, filed on Mar. 30, 2019.

(51) Int. Cl. H04L 29/06; H04L 9/32

(52) U.S. Cl. CPC H04L 63/0823; H04L 9/321; H04L 9/3236; H04L 9/3268

(57) ABSTRACT

A method of forming and operating a computer network that has a login procedure including generating a login certificate authority, signing a certificate signing request for each of a hub computer and a login, and generating a signed certificate for each of the hub computer and the login. The login procedure initiates a secure server using the login certificate authority, and transmits a request for a new login to a cloud server. The cloud server generates and transmits a signed certificate to the hub computer, and then an app computer device connects to the hub computer to receive the signed certificate. The received signed certificate is hashed to obtain a hash value, which is verified using a hash value of the signed certificate from the cloud server. The app computer device transmits a request for login to the hub computer, and receives the login certificate to login.

### BACKGROUND

The exemplary embodiments generally relate to formation and operation of a peer to peer network, such as a social network, for securely posting and sharing information between users on the network.

The interconnectivity of people over the internet and other networks continues to increase as telecommunication and computer technology continues to advance. In conventional social networks, for example, a first user may have a friend (a second user) that is a member of the same online service provider. The second user may also have additional connections to other users that use the same online service provider, and each of the other users are all connected to both the first user and the second user through their relationships and connections that form the social network. The social network is tracked and maintained by the online service provider.

In other words, the users of the social network may be nodes on a traditional computer network. However, in recent years, the users have developed an increased interest in the security and privacy of the information shared or otherwise available on the social network. There is a need for the ability for the nodes/users to be able to continue to interact with each other while also providing more secure control over the distribution of information flow between the users/nodes. An important aspect of this control is the ability for users to establish secure connections to other users to share information, such as the connections established on a peer-to-peer (P2P) network.

However, conventional social media networks are centralized around a central server or set of servers that control all aspects of the network. Conventional social networks control, for example, all user data and host the data on the social media website/platform. The user data is distributed throughout the servers of the social media network for internal analysis and for sale to third party services or users, which may then target advertisements and/or perform consumer and social research and analysis on the data. The centralized nature of conventional social media networks allows the social media company hosting the network to control and view the content posted, when the content is posted, where the user is located when posting the content, etc.

The access and control of information raises serious security and privacy concerns. Importantly, all of this access to information and exchanging of information is conventionally performed without sufficient encryption and security protocols for the benefit of the users on the social media network.

On a P2P network, a connection or link may represent or may be otherwise associated with a privilege to access certain information, such that a first person who has established a connection with a second person is authorizing the second person to view or access non-publicly available information. On the P2P network, the first user may be connected to multiple other users to share information to each of the users.

However, merely establishing a connection to other users using a P2P network does not itself provide complete security. P2P networks are beginning to provide some level of encryption for users. However, the encryption requires sharing of private keys or other sensitive information with a central server, which then eliminates the benefit of a decentralized network, for security purposes.

There is a need for a secure decentralized network that is easy to implement for users. There is a need for a social network that does not require the burdensome infrastructure of a traditional social network requiring a central online service provider or central server to track and maintain the users of the network and the information shared on the network.

### SUMMARY

The exemplary embodiments provide a system and method of constructing a peer-to-peer network to share information between users on the network without the use of a central server or online service provider, while also providing self-authenticating security for the information shared between each of the users on the network. The exemplary embodiments provide benefits of a decentralized P2P network in combination with using hashing, which is a blockchain style authentication of information shared on the network between users, as discussed in more detail below.

The exemplary embodiments implement a method of performing an initial login procedure for a network, the method including generating, by a hub computer, a certificate signing request and a corresponding private key for each of a hub certificate and a login certificate. The method then includes signing, by a hub computer, the certificate signing request of the login certificate with a generated self-signed login certificate authority, and generating a combined file of the login certificate authority and the private key. The method then includes initiating, by a hub computer, a secure server using the login certificate authority, and transmitting a request for a new login to a cloud server. The method then includes generating, at the cloud server, a signed certificate, transmitting the signed certificate to the hub computer, connecting, by an app computer device, to the hub computer, and receiving the signed certificate from the hub computer. The method then includes hashing the received signed certificate to obtain a hash value, and verifying the hash value using a hash value of the signed certificate from the cloud server. Further, the method includes transmitting, from the app computer device, a request for login to the hub computer, and receiving the login certificate from the hub computer to login.

The exemplary embodiments also implement a method of connecting with users on a network, the method including establishing, by an app computer device, a secure connection between the app computer device and a hub computer over the network, hashing, by the app computer device, a signed certificate retrieved from the hub computer, and verifying a hash value of the signed certificate. The method further includes transmitting, by the app computer device, a login certificate to the hub computer, and requesting, by the hub computer, a hash value of a hub certificate of a friend user and a corresponding port from a cloud server. The method further includes connecting, by the hub computer, to a friend hub computer using the port from the cloud server, and generating a second hash value of the hub certificate of the friend hub computer. The method further includes confirming, by the hub computer, that the hash value of the hub certificate of the friend user received from the cloud server matches the second hash value, and transmitting, by the hub computer, a login certificate to the friend hub computer to gain access to posts by the friend stored on the friend hub computer.

The exemplary embodiments also implement a method of accessing posts of another user on a network, the method including transmitting, by an app computer device of a user, a request to a hub computer of the user to acquire a new post from a friend user from a friends list of the user, and transmitting, by the app computer device, a request to a friend hub computer of the friend user. The method further including receiving, by the app computer device from the friend hub computer, a response including the new post of the friend, and providing the new post to the user of the app computer device.

The exemplary embodiments provide an improved network that allows for implementing a secure decentralized network that is easy for users to setup and operate without the continued monitoring and dependence on a central server. The exemplary embodiments provide that the hub computer for each user generates its own Certificate Signing Request (CSR) and a corresponding private key, and sends the CSR to the cloud server to perform signing of a certificate. The hash value of the signed certificate (SSL certificate) is then used by the app on the user's computer device (app computer device) to establish a secure connection, and the hub computer uses the signed certificate to host an HTTPS server. A similar principle is then applied to authenticating the identity of each friend user for different operations requiring secure connections to the other devices on the network. The Login certificate authority (CA) is used to sign login certificates and to verify signed certificates, which are used to verify or authenticate users.

In addition, the network implements hashing to reduce the file size of information shared over the network and the amount of information that must be shared between devices on the network in order to obtain security and authenticate information. The functionality of the network is improved by reducing the amount of information that is required to be transferred between devices on the network. The storage capacity or storage requirements of each of the devices may be more efficiently used or reduced by reducing the amount of data that must be used for authentication and security. By implementing hashing of data, the values of the hash serve to minimize the amount of data necessary to provide security and authentication.

In order words, instead of storing the entire certificate in the app computer device for each hub computer, the app computer device only needs to store the hash value of the certificate, which is comparatively negligible in size. Newer processors have built-in hardware on the IC chips that allow for extremely fast and efficient hashing. By using this hashing technique, and then comparing the hash values, the network has added security when connecting to hub computers. This also ensures that a third party cannot intercept the connection, which makes the connection additionally secure.

### BRIEF DESCRIPTION OF THE DRAWINGS

FIG. 1 illustrates a block diagram of the network during formation and login phases of the network according to an exemplary embodiment;

FIG. 2 illustrates a block diagram of the network after initial formation of the network that includes at least two users according to an exemplary embodiment;

FIG. 3 illustrates a flowchart of an initial login procedure by a hub computer according to an exemplary embodiment;

FIG. 4 illustrates a flowchart of an initial login procedure by the hub computer according to an exemplary embodiment;

FIG. 5 illustrates a flowchart of an initial login procedure by a cloud server according to an exemplary embodiment;

FIG. 6 illustrates a flowchart of an initial login procedure by an app computer device according to an exemplary embodiment;

FIG. 7 illustrates a flowchart of an initial connecting to other users procedure by the app computer device according to an exemplary embodiment;

FIG. 8 illustrates a flowchart of an initial connecting to other users procedure by the hub computer according to an exemplary embodiment;

FIG. 9 illustrates a flowchart of an initial connecting to other users procedure by the cloud server according to an exemplary embodiment;

FIG. 10 illustrates a flowchart of establishing a secure connection by the app computer device according to an exemplary embodiment;

FIG. 11 illustrates a flowchart of establishing a secure connection by the hub computer according to an exemplary embodiment;

FIG. 12 illustrates a flowchart of a process of a first post of data by the app computer device according to an exemplary embodiment;

FIG. 13 illustrates a flowchart of a process of a first post of data by the hub computer according to an exemplary embodiment;

FIG. 14 illustrates a flowchart of a process of additional posts of data by the app computer device according to an exemplary embodiment;

FIG. 15 illustrates a flowchart of a process of additional posts of data by the hub computer according to an exemplary embodiment;

FIG. 16 illustrates a flowchart of a process of acquiring posts of other users by the app computer device according to an exemplary embodiment;

FIG. 17 illustrates a flowchart of a process of acquiring posts of other users by the hub computer according to an exemplary embodiment; and

FIG. 18 illustrates a flowchart of a process of acquiring posts of other users by a hub computer of a friend user according to an exemplary embodiment.

### DETAILED DESCRIPTION

The exemplary embodiments relate to system and computer-implemented method of forming a secure peer-to-peer (P2P) network. The P2P network is formed by a plurality of users, as known as nodes. Each user has a hub computer, an application-enabled computer device (app computer device), such as a smartphone or portable computer, on which an application is installed that enables access to and operation on the P2P network, and a cloud server or group of servers. However, an alternative embodiment provides that the hub computer and the app computer device of the user are a single device, instead of two distinct computer devices. The details and processes of each of these devices will be discussed in detail below with respect to the drawings.

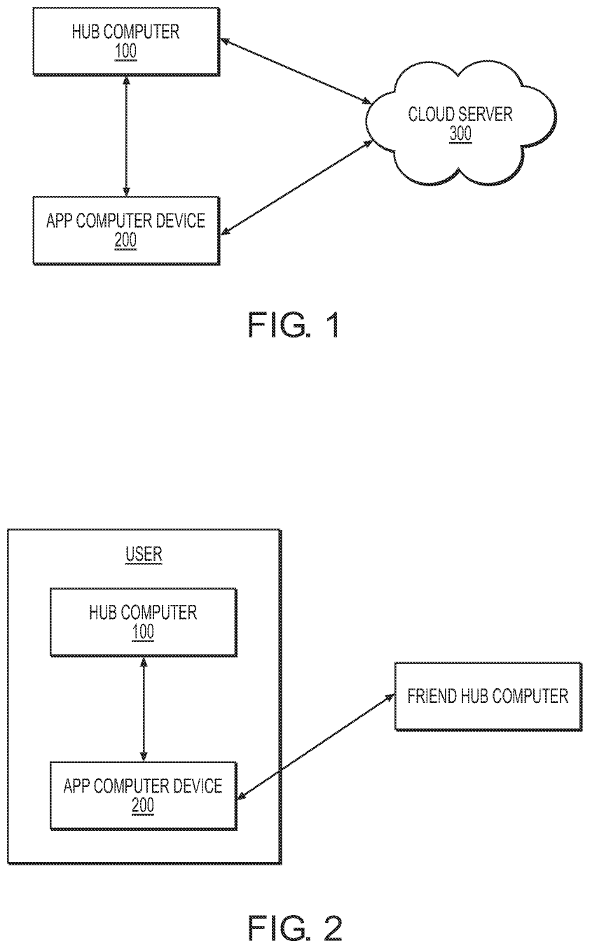

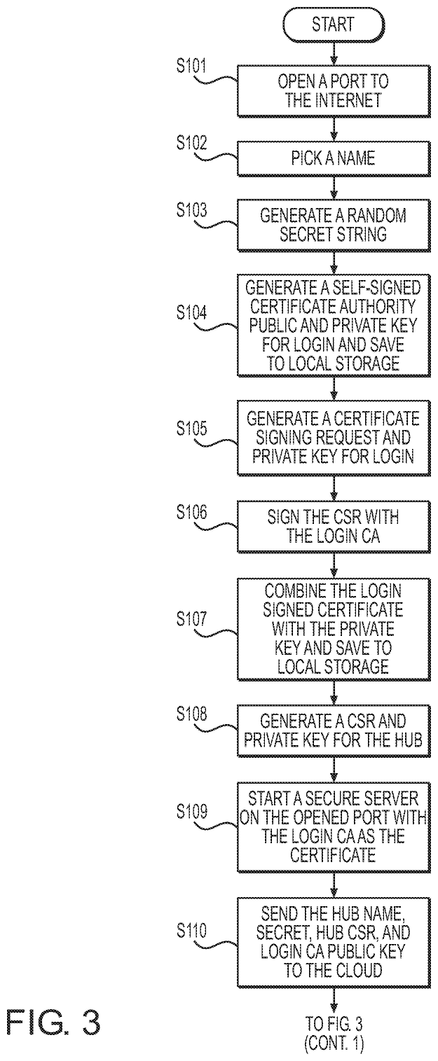

For purposes of clear and concise explanation, the following description will be made from the perspective of a first user. However, this description applies equally to each user (friend user) accessing and forming the P2P network described herein. As shown in FIGS. 1 and 2, the first user has a hub computer 100 and an application-enabled computer device (app computer device) 200, and the first user accesses a cloud server (or group of servers) 300. Each of these devices is formed of known computer hardware, such as memory (ROM, RAM, etc.) and processors, which are not separately described herein for conciseness.

### Overview

As shown in FIGS. 1 and 2, the P2P network according to the exemplary embodiments is formed by, for example, the hub computer 100 performing an initial login procedure to generate a signed login certificate and private key to be used for authentication during subsequent login and for connection to other users (e.g., adding a friend). The application-enabled computer device 200 (i.e., app computer device) has an application (i.e., an app) installed therein that allows the app computer device 200 to act as an interface for the user to connect to the user's hub computer 100 and to hub computers of any friend users to share or acquire/view content shared by the friend users. As discussed in more detail below, each of the hub computer 100 and the app computer device 200 connect to a cloud server 300 during an initial formation of the network (e.g., during a login procedure, and adding a friend user to the network). After the initial formation of the network and after adding friends to the network, the user and each friend communicate and share information securely through peer-to-peer communication without the use of the cloud server 300. Each of the processes used in forming and operating the P2P network will be described below in detail.

### Login Procedure

### Hub Computer 100

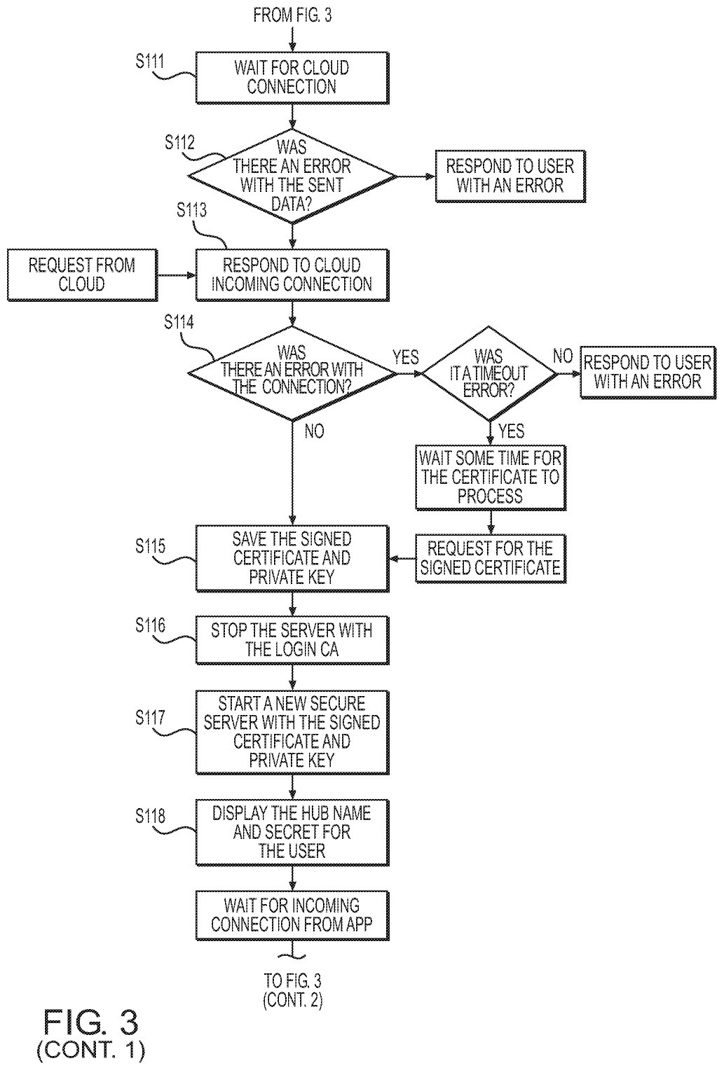

The hub computer 100 is an “always on” type computer, which stores information for the user and may be accessed or shared by the user upon request over the network, once established. As shown in FIG. 3, during an initial login procedure, at Step S101, the hub computer 100 opens a port P to the internet. The port P may be opened using known techniques, such as universal plug and play (UPnP) or manually.

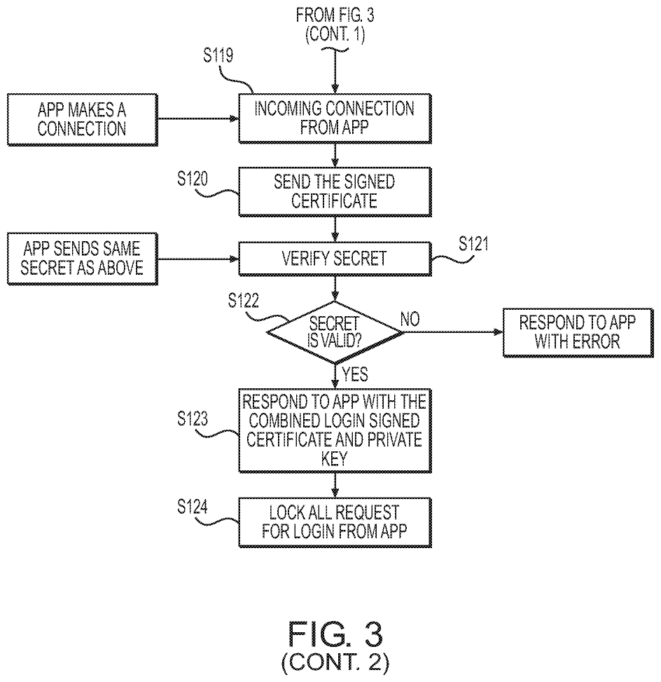

At Step S102, the user assigns a domain name and, at Step S103, generates a random secret string used for authentication of app computer device 200 to the hub computer 100. This is a one-time use random secret. As shown in FIG. 4, at Steps S104-S108, the hub computer 100 generates Secure Sockets Layer (SSL) certificates. The certificates are generated by, at Step S104, generating a self-signed certificate authority (CA) public key and a corresponding private key. The self-signed CA public and private keys are used for the login procedure and saved to a local storage on the hub computer. The common name of the certificate authority (CA) will be the name of the hub computer 100, i.e., the hub name, which is pre-assigned to the hub computer 100. However, the hub name may be changed or separately assigned as long as the hub name and the CA common name are the same at this stage, and remain the same because the hub name will be used for verification by other users (friends) on the network after formation of the network and connection with other users (friends).

At Step S105, a certificate signing request and a corresponding private key are generated for the login. The common name for the certificate signing request and private key is the name of the “client”, such as, for example, the hub name plus “client” or the name of the application on the application-enabled computer device 200 that will access the hub computer 100. Meaning, the common name be assigned to any name as desired by the user.

At Step S106, the generated certificate signing request is signed using the self-signed Login CA generated in Step S104. By signing the certificate signing request with the Login CA, a Login Signed Certificate is generated. At Step S107, the Login Signed Certificate is combined with the private key, and the resulting combination is stored in a local storage or memory of the hub computer 100. The combined login signed certificate and private key are stored in, for example, a PKCS#12 file format, which is then used by the app computer device 200 when transmitting any request to a hub computer of another user (friend).

At Step S108, generate a new certificate signing request (CSR) and corresponding private key for the hub computer 100 to transmits to the cloud server 300 in order to sign the CSR using a third party Trusted CA, a discussed in more detail below. The CSR is generated using the hub name, which is also the domain name system (DNS) name.

At Step S109, as shown in FIG. 3, the hub computer 100 initiates a secure server, which will accept a connection from the cloud server 300, at Step S113 discussed below, on the open port P, as opened in Step S101, using the Login CA certificate generated at Step S104. At Step S110, the hub computer 100 sends the hub name, a secret (password), the CSR generated at Step S108, and the public key of the Login CA to the cloud server 300. This information serves as a request for a new login.

At Step S111, the hub computer 100 waits for a response from the cloud server 300, and at Step S112, the hub computer determines whether an error exists in the information sent from the hub computer 100 to the cloud server 300 based on a response from the cloud server 300. When the cloud server 300 responds with an error, then the hub computer 100 transmits or otherwise provides an error message to the user. Alternatively, the process proceeds to Step S113, where the cloud server 300 transmits a request for information and for connection, then the hub computer 100 responds to the request from the cloud server 300. The request for connection is to connect to the secure server initiated by the hub computer 100 at Step S109, such that now the cloud server 300 initiates and establishes the connection to the secure server. If the connection is successful, this will verify that the hub computer 100 has access to the private key corresponding to the public key of the Login CA sent to the cloud server 300. The request from the cloud server 300 will be discussed in more detail below with respect to the processes performed by the cloud server 300 during the login operation.

At step S114, the hub computer 100 determines whether an error exists in the newly established connection with the cloud server 300. When the error is a timeout error due to a predetermined period of time elapsing without a response, then the hub computer 100 waits an additional predetermined amount of time for the cloud server 300 to process the certificate and establish a secure connection. During the additional amount of time, the hub computer 100 transmits a request for a signed certificate to the cloud server 300. Alternatively, when the error in the connection is not a timeout error, the hub computer 100 transmits or otherwise indicates to the user that an error exists in the connection and a connection is not securely established.

At Step S115, once a connection is securely established and no errors currently exist in the connection, the hub computer 100 receives the signed certificate from the cloud server 300. The signed certificate is now a trusted certificate for the hub computer 100, which is used to verify that the hub computer 100 is a trusted server/device. This indication that the hub computer 100 is a trusted device allows the app computer device 200 to be able to connect to the hub computer 100 because the app computer device 200 is only permitted to connect to a trusted device/server.

At Step S116, the hub computer 100 stops listening for new connections in using the Login CA. At Step S117, the hub computer 100 begins listening for new connections with the app computer device 200 using the signed certificate received from the cloud server 300 at Step S115. At Step S118, the hub computer 100 displays the hub name and the secret to the user of the hub computer 100.

The hub computer 100 then awaits a connection from the app computer device 200, which is then established by a connection request from the app computer device 200 at Step S119. The details of the connection request from the app computer device 200 will be discussed in more detail below. At Step S120, the hub computer 100 transmits the signed certificate to the app computer device 200 in response to the established connection with the app computer device 200. In response, the hub computer 100 receives a secret from the app computer device 200, and at Step S121, verifies whether the secret received from the app computer device 200 matches the secret used for the signed certificate, which is the secret transmitted to the cloud server 300 at Step S110 and displayed to the user at Step S118.

At Step S122, if the secret received from the app computer device 200 is not verified and does not match the secret linked to the signed certificate, then the hub computer 100 transmits or otherwise notifies the app computer device 200 that an error has occurred in the connection between the hub computer 100 and the app computer device 200. If the secret received from the app computer device 200 is verified to match the secret linked to the signed certificate, then at Step S123, the hub computer 100 responds to the app computer device 200 with a combined Login Signed Certificate and the corresponding private key (e.g., a PCKS#12 file).

At Step S124, the hub computer 100 confirms the connection with the app computer device 200 and locks further requests for login from the app computer device 200.

### Cloud Server 300

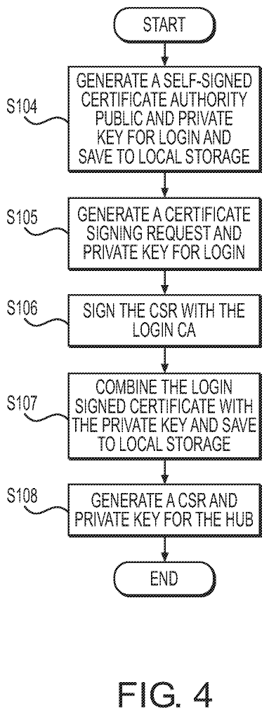

The cloud server 300 is a single server or group of servers. As shown in FIG. 5, at Step S301, the cloud server 300 receives the connection request from the hub computer 100, as a new hub connection. At Step S302, the cloud server 300 parses the incoming data from the hub computer 100 when requesting the connection to the cloud server 300. The incoming data from the hub computer 100 includes, for example, the internet protocol (IP) address of the hub computer 100, the port P of the hub computer 100, the hub name, the CSR generated by the hub computer 100 (hub CSR), the public key of the Login CA (CAcert), and the secret assigned by the user on the hub computer 100.

At Step S303, the cloud server 300 validates the parsed incoming data. The validation is performed by, for example, (i) determining whether the hub name already exists in the storage records of the cloud server 300, (ii) verifying, if applicable, any payment to any subscription or processing fees necessary to the cloud server 300, (iii) the common name of the CSR matches the hub name, and (iv) the CAcert is a certificate authority and includes the hub name. The validation may include some, all, or additional steps or processes as well. If one of the steps or processes of the validation fails, then the entire validation fails and an error is transmitted or otherwise provided to the hub computer 100.

If the validation is successfully completed, then the process moves to Step S304. At Step S304, the cloud server 300 determines whether the hub computer 100 exists by transmitting an HTTPS request to the hub computer 100 at the IP address and the port P included in the incoming data. If the hub computer 100 responds to the HTTPS request, then the cloud server 300 determines that the hub computer 100 exists due to the response, and then process proceeds to Step S305. If the hub computer 100 does not respond, then the cloud server 300 determines that an error exists in the connection request from the hub computer 100 and the cloud server 300 responds with an error.

At Step S305, the cloud server 300 determines whether to sign the CSR with a 3^{rd} party trusted Root Certificate Authority, or an untrusted Root Certificate Authority installed on the hub computer 100. If the cloud server 300 determines to sign the CSR using an untrusted Root CA, then the cloud server retrieves the Root CA from the local storage of the hub computer 100, which includes both the CA public key and the private key, and then signs the CSR of the hub computer 100 with the retrieved Root CA.

If the cloud server 300 determines to sign the CSR using a 3^{rd} party trusted Root CA, then the process proceeds to Step S306. At Step S306, the cloud server 300 transmits the CSR of the hub computer 100 to the 3^{rd} party trusted CA, and at Step S307, the cloud server 300 completes all procedures and requirements of the 3^{rd} party trusted CA in order to achieve the signing of the CSR by the 3^{rd} party trusted CA. At Step S308, the cloud server 300 checks for errors in the 3^{rd} party trusted CA, and if none exists, then the process proceeds to Step S309. If an error exists, the cloud server 300 issues or transmits an error to the hub computer 100.

At Step S309, the cloud server 300 receives or retrieves the signed certificate from either the 3^{rd} party trusted CA or the Root CA, and at Step S310, stores the signed certificate. At Step S310, the cloud server stores the hub data in connection with the stored signed certificate. The stored hub data includes the IP address of the hub computer 100, the hub name of the hub computer 100, a hash value of the secret of the hub computer 100, a hash value of the signed certificate, and the CAcert.

At Step S311, the cloud server 300 determines whether the hub computer 100 is still connected to the cloud server 300. The hub computer 100 may lose connection with the cloud server 300 during the signing process of the CSR due to the length of time that may be required to complete the signing process. In the event a disconnection between the cloud server 300 and the hub computer 100, the stored signed certificate at Step S310 will remain stored for retrieval once connection is re-established between the hub computer 100 and the cloud server 300.

When the hub computer 100 has remained connected to the cloud server 300 during the signing process of the CSR, at Step S312, the signed certificate is directly sent to the hub computer 100. In the event that the hub computer 100 is disconnected from the cloud server 300, at Step S314, the cloud server 300 continues to store the signed certificate and waits for the connection between the hub computer 100 and the cloud server 300 to be re-established. Once the connection is reestablished, at Step S315, the cloud server 300 receives a request from the hub computer 100 from the signed certificate. At Step S316, the cloud server 300 retrieves the signed certificate, and at Step S317, the cloud server 300 transmits the signed certificate to the hub computer 100 in response to the request from the hub computer 100. Upon transmitting the signed certificate, at Step S318, the cloud server 300 deletes the signed certificate from the storage of the cloud server 300.

Once the cloud server 300 transmits the signed certificate to the hub computer (either at Step S312 or Step S317), the cloud server 300 routes a domain name system (DNS) for the hub name and IP address of the hub computer 100, at Step S313.

### App Computer Device 200

The app computer device 200 is a computer device of the user, which is different than the hub computer 100. The app computer device 200 may be a handheld compute device, such as a smartphone, laptop, tablet, etc., or another non-portable computer device. The app computer device 200 includes memory (e.g., RAM, ROM, etc.) and processor(s). The app computer device 200 includes a display 201 and input device 202. The display 201 displays an application interface to the user, and the input device 202 allows the user to input information. The display 201 and the input device 202 may be the same device, such as a touch-enabled display.

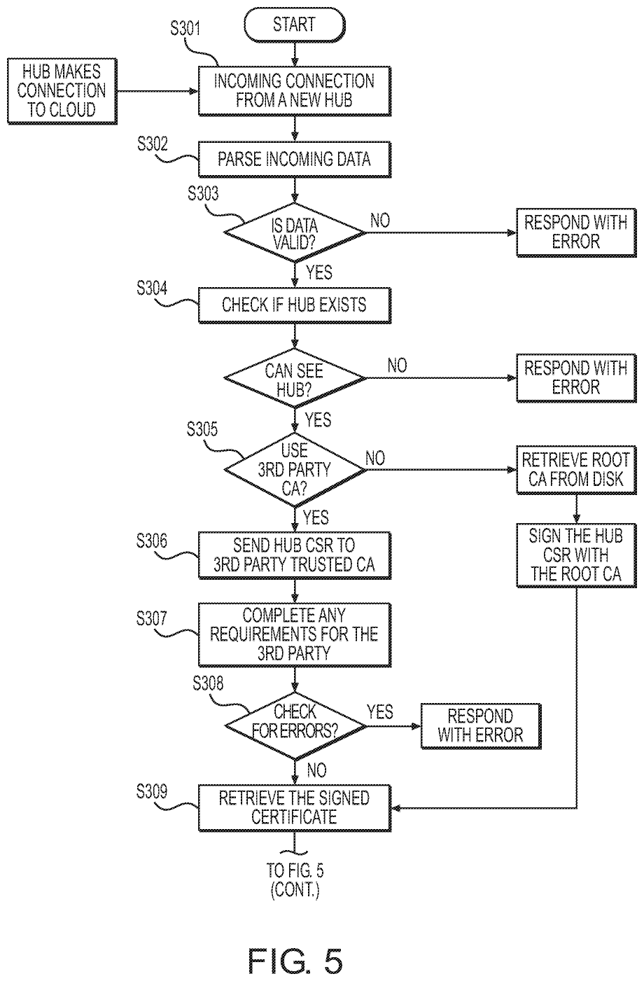

As shown in FIG. 6, at Step S201, the user inputs the hub name into the application interface displayed by the display 201 on the app computer device 200. The hub name will allow the app computer device 200 to identify the IP address of the hub computer 100 using the DNS generated by the cloud server 300 in Step S313. At Step S202, the app computer device 200 receives the port P of the hub computer 100 and the hash value of the signed certificate from the cloud server 300.

At Step S203, the app computer device 200 stores the port P of the hub computer 100 and the hash value of the signed certificate. At Step S204, the app computer device 200 connects to the hub computer 100 using the DNS and the port P received from the cloud server 300 using the hub name. At Step S205, the app computer device 200 requests or retrieves the signed certificate from the hub computer 100.

At Step S206, the app computer device 200 hashes the signed certificate received from the hub computer 100 and compares the hash value of the signed certificate received from the cloud server 300. At Step S207, if the hash values do not match, then the app computer device 200 issues an error to the user and terminates the login procedure. On the other hand, if the hash values match each other, then the process proceeds to Step S208.

At Step S208, the user of the app computer device 200 inputs the secret assigned and displayed to the user at the hub computer 100 at Step S118. At Step S209, the app computer device 200 transmits the inputted secret to the hub computer 100 as a part of a request for login to the hub computer 100 from the app computer device 200. At Step S210, the app computer device 200 receives, as a response from the hub computer 100, the Login Certificate and Private Key in, for example, PKCS#12 format. Then, at Step S211, the app computer device 200 stores the Login Certificate and Private Key on the app computer device 200.

The above-mentioned exemplary login procedure provides an improved network that allows for implementing a secure decentralized network that is easy for users to setup and operate without the continued monitoring dependence on a central server. The exemplary login procedure provides that the hub computer for each user generates its own Certificate Signing Request (CSR) and a corresponding private key, and sends the CSR and private key to the cloud server to perform signing of the certificate. The signed certificate (SSL certificate) is then used by the app on the user's computer device to establish a secure connection. The Login certificate authority (CA) is used to sign login certificates and to verify signed certificates, which are used to verify or authenticate users.

### Connecting with Other Users

### App Computer Device 200

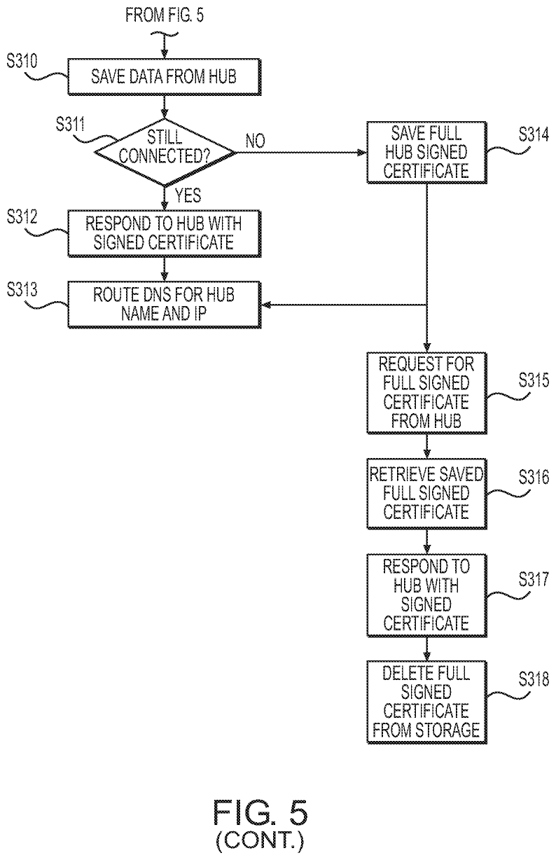

As shown in FIG. 7, at Step S220, the app computer device 200 receives an input from the user of a hub name of another user (i.e., a friend) to identify the hub computer of the friend. Each friend is also connected to, or has information stored on, the cloud server 300. The hub name of the friend will indicate the IP address of the hub computer of the friend through DNS. As Step S221, the app computer device 200 connects to the hub computer 100 of the user using the port P information saved by the app computer device 200.

As Step S222, the app computer device 200 retrieves the signed certificate from the hub computer 100, and hashes the retrieved signed certificate. At Step S223, the app computer device 200 compares the hash value of the retrieved signed certificate at Step S222, to the hash value received from the cloud server 300 at Step S202. If the hash values do not match, then issue an error to the user of the app computer device 200. If the hash values match, then the signed certificate is authenticated.

As Step S224, the app computer device 200 transmits the Login Certificate to the hub computer 100 for authentication by the hub computer 100. At Step S225, the app computer device 200 receives a response indicating whether the transmitted Login Certificate contains an error, such as the Login Certificate is not authentic, the Login Certificate is not signed by the Login CA of the hub computer 100, etc. If the Login Certificate contains an error, then the app computer device 200 issues an error to the user. If the Login Certificate does not contain an error, then the process proceeds to Step S226.

At Step S226, the app computer device 200 transmits to the hub computer 100 the inputted hub name of the friend's hub computer, which was previously input at Step S220. This constitutes the request to add a friend to the hub computer 100. At Step S227, the app computer device 200 transmits a request to the cloud server 300 requesting a hash value of the signed certificate of the hub computer of the friend (hereinafter hub certificate) and a port address of the hub computer of the friend.

At Step S228, the app computer device 200 receives the hash value of the hub certificate and the port of the hub computer of the friend, and stores all of this information on the app computer device 200.

### Hub Computer 100

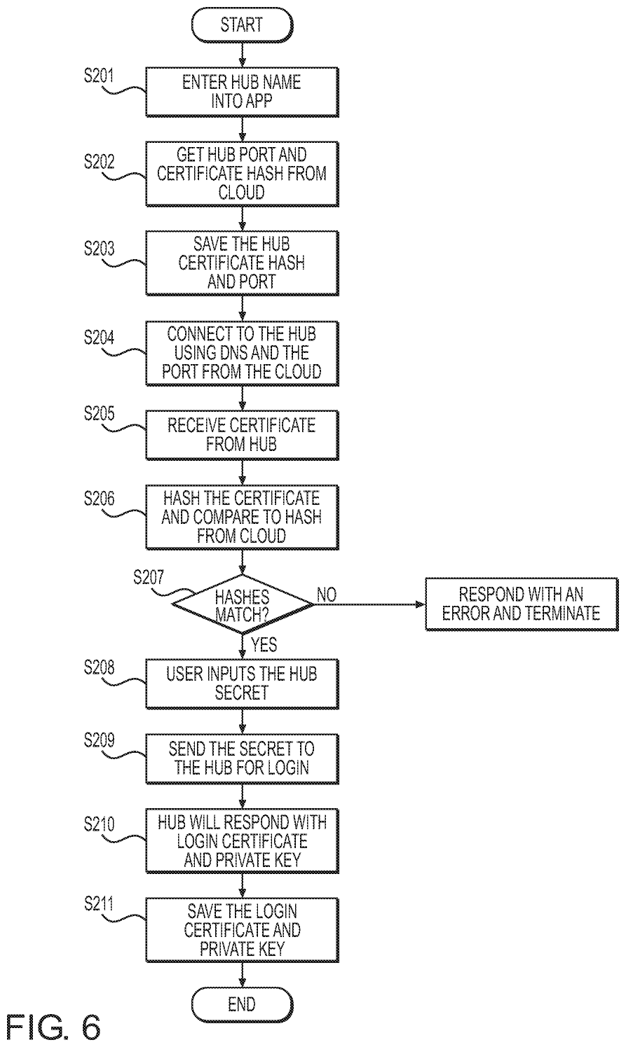

As shown in FIG. 8, at Step S130, the hub computer 100 receives an incoming connection from the app computer device 200. At Step S131, the hub computer 100 transmits the signed certificate of the hub computer 100 to the app computer device 200. In response to Step S224 of the app computer device 200 transmitting the Login Certificate, the hub computer 100 receives, at Step S132, the Login Certificate from the app computer device 200.

As Step S133, the hub computer 100 determines whether the Login Certificate is authentic by confirming that the Login Certificate has been signed by the Login CA of the hub computer 100. If the Login Certificate is not authentic, then the hub computer 100 issues an error. If the hub computer 100 determines that the Login Certificate is authentic, then the process proceeds to Step S134. At Step S134, the hub computer 100 receives the hub name of the friend from the app computer device 200 and parses the hub name of the friend. Upon parsing the hub name of the friend, at Step S135, the hub computer 100 requests a Login CA of the friend from the cloud server 300. At Step S136, the hub computer 100 determines whether an error exists in the request for the Login CA. The error may occur, for example, when the friend that the hub computer 100 is attempting to add does not exist, and the cloud server 300 does not have a Login CA that corresponds to the hub name of the friend.

If an error does not exist in the request for the Login CA, then the process proceeds to Step S137, and at Step S137, the hub computer 100 stores the Login CA of the friend as a Trusted Certificate Authority (CA). At Step S138, the hub computer 100 transmits an indication or message of success to the app computer device 200 and the user of the app computer device 200. At Step S139, the hub computer 100 waits for all connections to complete or terminate.

At Step S140, the hub computer 100 terminates the current server session and starts (or restarts) a server session using the new trusted CA (or multiple trusted CAs when multiple friends are added). At Step S141, the hub computer 100 requests from the cloud server 300 the hash value of the hub certificate, the hub certificate of the friend, and the port of the hub computer of the friend, and at Step S142, stores this information on the hub computer 100.

At Step S143, the hub computer 100 establishes a connection with the hub computer of the friend at the port received from the cloud server 300. Upon establishing the connection, at Step S144, the hub computer 100 receives the hub certificate from the hub computer of the friend, and hashes the received hub certificate from the friend. At Step S145, the hub computer 100 determines whether the hash value of the received hub certificate from the friend matches the hash value of the hub certificate of the friend received and stored from the cloud server 300. If the hub computer 100 determines that the hash values do not match, then the hub computer identifies the friend as being in error and issues an error alert to the app computer device 200 for the user. If the hash values match each other, then the process proceeds to Step S146.

At Step S146, the hub computer 100 transmits the Login Certificate to the hub computer of the friend. At Step S147, the hub computer 100 determines whether an error exists in the Login Certificate. The error occurs, for example, due to the friend having not adding the user of the hub computer 100 as a trusted user of the friend. When the hub computer 100 determines that the Login Certificate has an error, then the process proceeds to Step S160, as discussed in more detail below. When the hub computer 100 determines that no error exists in the Login Certificate, the process proceeds to Step S148.

At Step S148, the hub computer 100 transmits a latest post, which may include text or media, of the user to the friend. At Step S149, the hub computer 100 receives a latest post from the friend. At Step S150, the hub computer 100 stores the latest post received from the friend, and at Step S151, the hub computer 100 adds the friend to a Friends List of the user. The Friends List serves two primary functions, but may include additional functions. First, the Friend List includes a list of trusted certificate authorities associated with friend users, which are stored before the hub computer 100 listens for new connections from friend users and authorizes the hub computer 100 to initiate connections with the hub computers and app computer devices of the friend users (i.e., trusted certificate authorities) of the Friends List. The app computer device of each friend user will use the login certificate to connect to the hub computer 100 in order to retrieve posts and corresponding data, and the hub computer of each friend user will use the login certificate when the friend posts a new post. The hub computer of each friend connects to and notifies the hub computer 100 when the friend user posts a new post so that the app computer device 200 (via the hub computer 100) will know to retrieve the new post of the friend user. Second, the Friends List includes a list of hub names of the respective hub computers of the friend users. Each hub name is stored in association with a hub certificate hash and the port of the hub computer of each friend user of the Friends List.

Next, the process continues to Step S160, as an alternative to Steps S148-S149, when the hub computer 100 determines that the Login Certificate has an error, the hub computer 100 waits for the hub computer of the friend to connect to the hub computer 100. At Step S161, the hub computer 100 receives a latest post from the friend, and at Step S162, the hub computer 100 responds to and transmits a latest post of the user to the friend. The process then proceeds to Step S150, and the process continues as discussed above.

### Cloud Server 300

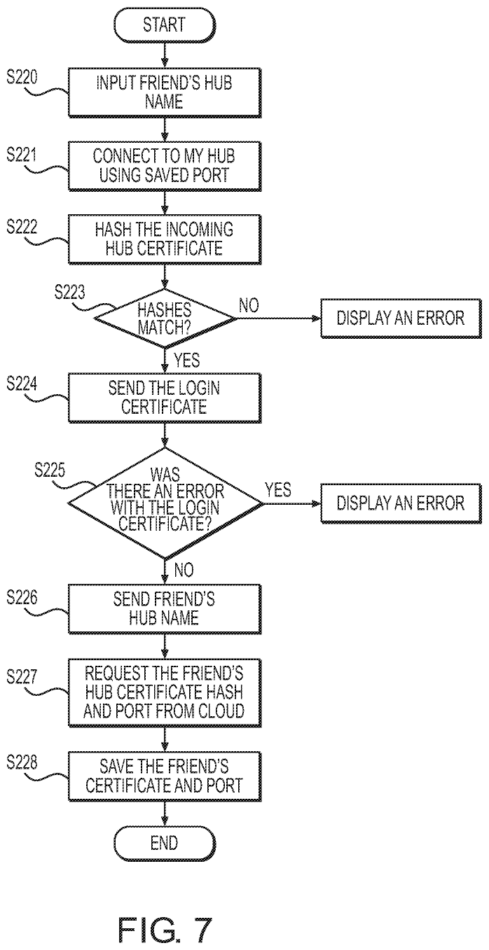

As shown in FIG. 9, at Step S330, the cloud server 300 waits from connections from the hub computer 100 and the app computer device 200 while processes are being performed by the hub computer 100 and the app computer device 200 for adding a friend. At Step S331, the cloud server 300 receives the connection from the hub computer 100. At Step S332, the cloud server 300 transmits the Login CA of the hub computer 100 to the hub computer 100, in response to the request from the hub computer 100.

At Step S333, the cloud server 300 receives the connection from the app computer device 200, and at Step S334, the cloud server 300 transmits to the app computer device 200 the hash value of the hub certificate and the port of the hub computer of the friend.

At Step S335, the cloud server 300 receives the connection from the hub computer 100, and at Step S336, the cloud server 300 transmits to the hub computer 100 the hash value of the hub certificate, the Login CA certificate of the friend, and the port of the hub computer of the friend.

### Establishing a Secure Connection

As discussed above, during operation of the processes discussed herein, the security of the network and the communications between the devices and users on the network is critical. In order to maintain a high level of security on the network, the connections between the devices on the network must be as secure as possible. The following description sets forth an exemplary process of establishing securing connections between the app computer device 200 of the user, the hub computer 100 of the user, and the hub computer of a friend user, such as the friend added in the previous section above. The following processes of establishing secure connections are not limited to the following devices and users, and may be applied to any hub computer and app computer device of any user on the network.

### App Computer Device 200

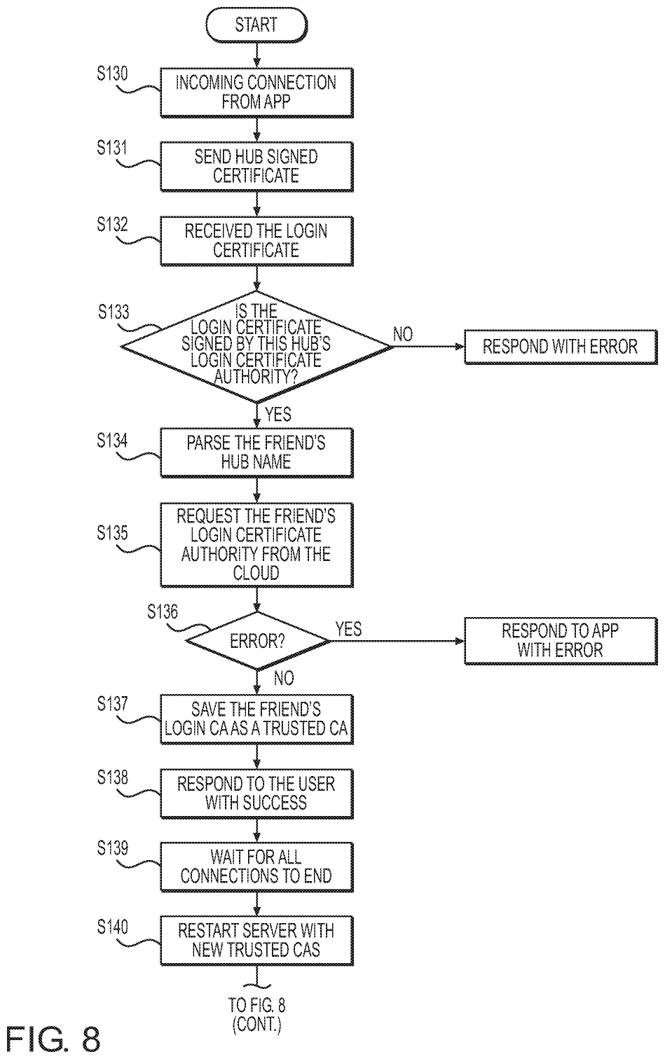

As shown in FIG. 10, at Step S230, the app computer device 200 establishes a connection to the hub computer 100 using the port P information stored on the app computer device 200. The hub name of the hub computer 100 is used as the DNS name for obtaining the IP address of the hub computer 100. At Step S231, the app computer device 200 receives the signed certificate from the hub computer 100 and hashes the received signed certificate. At Step S232, the app computer device 200 determines whether the hash value of the received signed certificate matches the hash value stored on the app computer device 200, which was previously received from the cloud server 300. If the hash values do not match, the app computer device 200 issues an error to the user. If the hash values match, the process proceeds to Step S233.

At Step S233, the app computer device 200 transmits the Login Certificate to the hub computer 100 to establish a secure connection with the hub computer 100. In the event that the app computer device 200 is attempting to establish a secure connection with the hub computer of a friend, then the app computer device 200 transmits the Login Certificate to the hub computer of the friend.

At Step S234, the app computer device 200 determines whether an error exists or occurred in the Login Certificate transmitted to the hub computer 100 and/or the hub computer of the friend. When the app computer device 200 determines that an error exists, the app computer device 200 issues and/or displays an error to the user. When the app computer device 200 determines that an error does not exist, the secure connection is established between the app computer device 200 and the hub computer 100 and/or the hub computer of the friend.

### Hub Computer 100

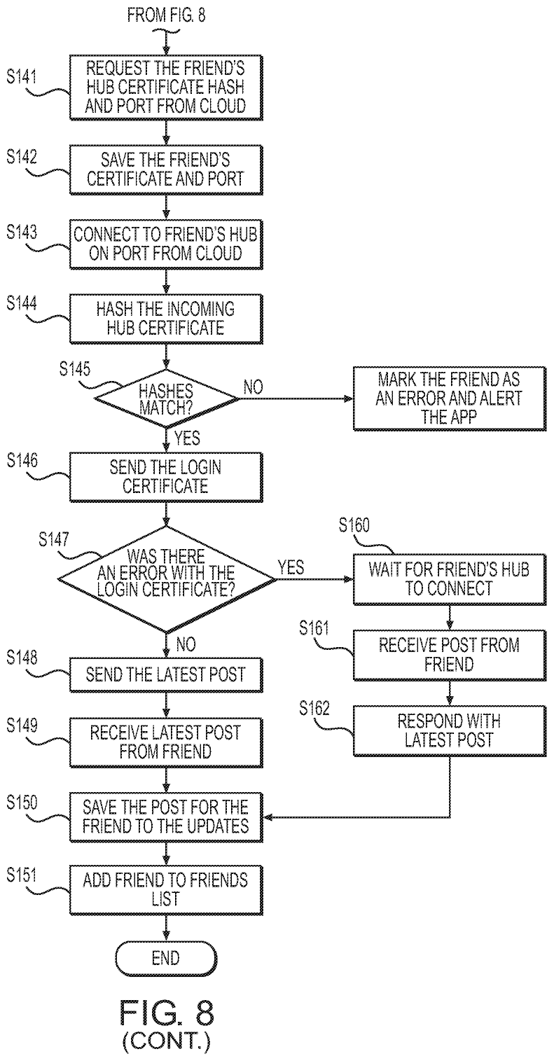

As shown in FIG. 11, at Step S170, the hub computer 100 receives a request from the app computer device 200 for the signed certificate and transmits the signed certificate to the app computer device 200. At Step S171, the hub computer 100 receives the Login Certificate from the app computer device 200.

At Step S172, the hub computer 100 determines whether the received Login Certificate is authentic by determining whether the Login Certificate is signed by the Login CA of the hub computer 100. When the hub computer 100 determines that the Login Certificate is not signed by the Login CA, the hub computer 100 determines that an error exists in the received Login Certificate and issues an error indication to the app computer device 200. When the hub computer 100 determines that the Login Certificate is signed by the Login CA of the hub computer 100, the hub computer 100 determines that the Login Certificate is authentic and confirms the secure connection with the app computer device 200.

When the app computer device 200 is attempting to establish a secure connection to the hub computer of the friend or another user, the hub computer of the friend performs the same processes as the hub computer 100, discussed above. The primary difference is that hub computer of the friend determines whether the Login Certificate is authentic by determining whether the Login Certificate is signed by a Certificate Authority of a user in the Friends list, which means that the user requesting to connect is a friend/trusted user.

### Posting Information to the Network

As discussed above, the formation of the network between the devices of the user and the devices and connections with the friend(s) creates a social network environment. In this social network, the user may “post” or share information/data with other users/friends on the network. The information is shared by “posting” the information, which is a process that will be described in detail below. The information that is posted may any type of information that the user would like to share, such as visual media, audio media, text, etc.

The following description relates to posting information for the first time.

### App Computer Device 200

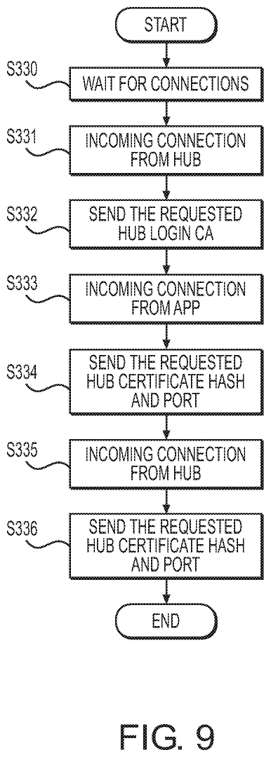

As shown in FIG. 12, at Step S240, the app computer device 200 receives an input of the data/information to be included in a first post and an indication that this data/information will be a post. At Step S241, the app computer device 200 establishes a secure connection with the hub computer 100 through the process discussed above for “Establishing a Secure Connection.”

At Step S242, the app computer device 200 transmits the data for the first post to the hub computer 100. At Step S243, the app computer device 200 determines whether an error exists in the data of the first post or the transmission of the data to the hub computer 100. If an error exists, then the app computer device 200 issues and/or displays the error to the user of the app computer device 200.

If an error does not exist, the app computer device 200, at Step S244, alerts/notifies the user of the app computer device 200 that the post was successfully shared or “posted” to be available for access by friends of the user on the Friends List.

### Hub Computer 100

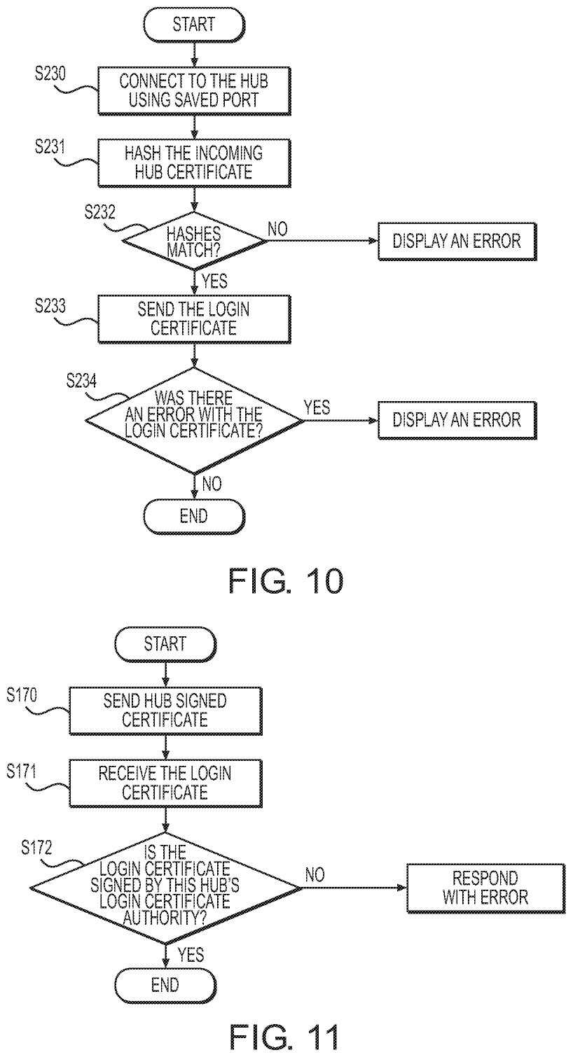

As shown in FIG. 13, at Step S180, the hub computer 100 receives a connection request from the app computer device 200. At Step S181, the hub computer 100 establishes a secure connection with the app computer device 200 (similar to Step S241 performed by the app computer device 200). At Step S182, the hub computer 100 receives the data to be included in the first post from the app computer device 200, and parses the incoming data, which determines the type of post and the data to be included in the post. At Step S183, the hub computer 100 hashes and stores the received and parsed data for the first post. The data is stored to a file with a file name that is a hash value of the data.

At Step S184, the hub computer 100 creates/partitions a storage block of the memory of the hub computer 100. For example, for a first post, the previous hash value is set as 0×64 and the hash value of the data is set as the name of the file. The storage block also includes metadata of the post, such as a creation time, modification time, and the type of the post, etc. At Step S185, the hub computer 100 stores the available information into the storage block. The storage block is stored to a file with a file name that is the hash value of the data.

At Step S186, the hub computer 100 responds to the app computer device 200 indicating a successful completion of the first post. If the first post is created prior to adding any friends to the Friends List, then the process ends. If the first post is created after adding at least one friend to the Friends List, then the process continues, as discussed below, to send the post to the friend(s) on the Friends List.

After posting the first post and adding at least one friend to the Friends List, the following process is performed for posting data in an additional subsequent post.

### App Computer Device 200

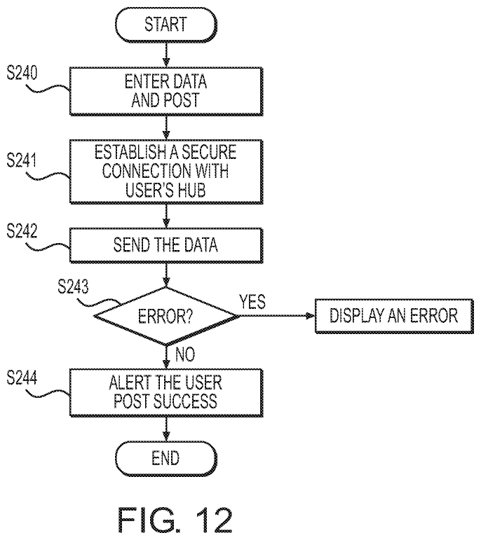

As shown in FIG. 14, the app computer device 200 performs substantially the same processes as the app computer device 200 when posting the first post. Steps S245-S249 are substantially the same as Steps S240-S244. For example, at Step S245, the app computer device 200 receives an input of the data/information to be included in a first post and an indication that this data/information will be a post. At Step S246, the app computer device 200 establishes a secure connection with the hub computer 100 through the process discussed above for “Establishing a Secure Connection.”

At Step S247, the app computer device 200 transmits the data for the first post to the hub computer 100. At Step S248, the app computer device 200 receives a response from the hub computer 100 indicating whether an error exists or whether the post is successfully posted.

If an error does not exist, the app computer device 200, at Step S249, alerts/notifies the user of the app computer device 200 that the post was successfully shared or “posted” to be available for access by friends of the user on the Friends List.

### Hub Computer 100

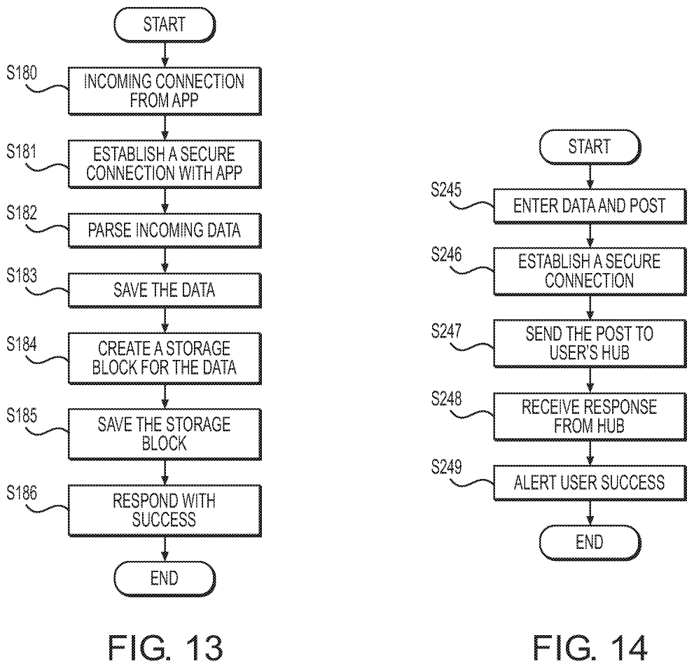

As shown in FIG. 15, Steps S187-S190 are the same as Steps S180-S183, as explained in detail above. For conciseness, the details of Steps S187-S190 are not repeated. At Step S191, the hub computer 100 creates a new storage block of the memory of the hub computer 100 for storing the incoming data received and parsed from the app computer device 200. The new storage block stores the previous hash value of the prior post, which may be the first post if this is the second post, and stores a hash value of the incoming data of the current post. Similar to Step S184, the new storage block will store the metadata for the new post, such as the time of creation and the type of the new post, which are indicated by the parsed incoming data received from the app computer device 200.

At Step S192, the new storage block is saved and storage in the memory of the hub computer 100. At Step S193, the hub computer responds to the app computer device 200 to notify the app computer device 200 and the user of the success of creating the new post.

At Step S194, the hub computer 100 searches the memory and locates the Friends List. At Step S195, the hub computer 100 reviews and analyzes the Friends List to determine the friends that should receive the new post and have not received the new post. When the Friends List includes friends to receive the new post, the hub computer 100 establishes a secure connection with a hub computer of each of the friends on the Friends List. Each secure connection is established using the process described above for “Establishing a Secure Connection.” Upon establishing the secure connection to a friend on the Friends List, the hub computer 100 transmits the hash value of the storage block, which is included in the metadata of the new post, to the hub computer of each friend on the Friends List.

In the event that a secure connection cannot be established with a friend on the Friends List, which may occur if the hub computer of the friend is offline, the friend will be skipped for sending the post at this time and the hub computer 100 will send the post when attempting to send a future new post to the friend. Alternatively, when the hub computer of the friend reestablishes a secure connection with the hub computer 100 prior to the future new post, the hub computer of the friend may request or retrieve the post that it did not previously receive.

### Accessing Post of Another User on the Network

As a part of the social network, users will post and share information/data of their own, and users will also view information/data of other users (friends). The following processes describe an exemplary embodiment of accessing a post or posts from friends on the Friends List of the user of the hub computer 100 and the app computer device 200.

### App Computer Device 200

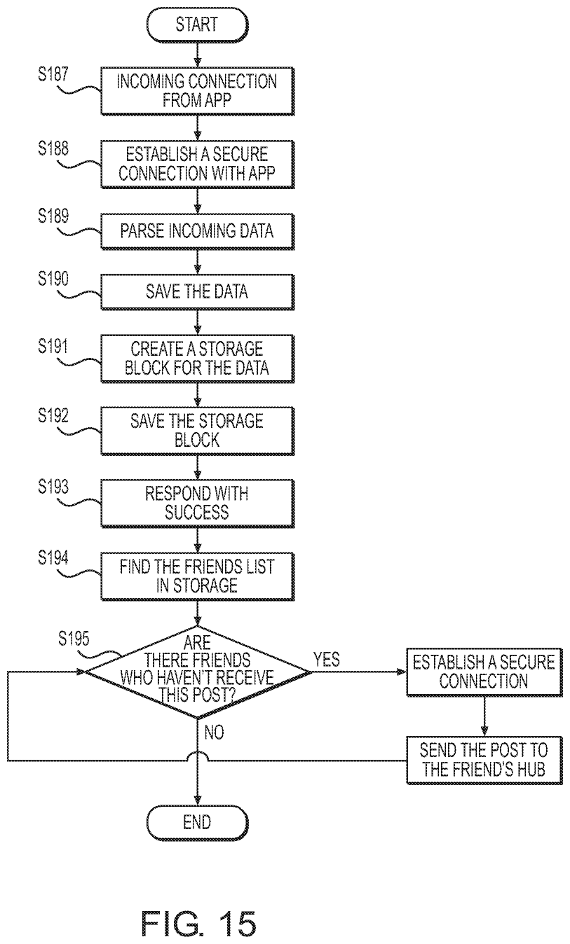

As shown in FIG. 16, at Step S250, the app computer device 200 receives a request input by the user for all most recent (up-to-date) posts from the friends on the Friends List. At Step S251, the app computer device 200 transmits a request to the hub computer 100 to acquire a current version of the Friends List and all new or most recent posts from the friends on the Friends List. In order to determine the most recent friends of the Friends List and the most recent or new posts, the hub computer 100 will organize all received posts from the friends of the Friends List in the order in which the posts were received by the hub computer 100.

At Step S252, the app computer device 200 receives and parses the current version of the Friends List and all new or most recent posts from the friends on the Friends List. At Step S253, the app computer device 200 transmits a request to the hub computers of all friends on the Friends List, which requests the hash value of the most recent or new post posted by each friend on the Friends List. At Step S254, the app computer device 200 receives a response from the hub computer(s) of each of the friends on the Friends List. The response will include, for the new or most recent post of each friend, the data of the post, a hash value of the post data, the metadata of the post (e.g., creation and/or modification time, the type of the post, etc.), and a prior value of the hash of an immediately prior post (if any), which will show the continuity of the post with prior posts by the friend.

The previous hash value of the post that the friend posted immediately prior to the new or most recent post serves as a security measure to maintain continuity and consistency of the records on the hub computer 100 with the records of the hub computer of the friend. The hash values of each post allow for a blockchain-style of security records in which the hub computer 100 is able to use the hash values as a security measure, where the hash value of the post immediately prior to the new post must match the records of the prior post stored on the hub computer 100 when the hub computer 100 received the prior post from the friend in the past. In other words, the hub computer 100 and the friend each maintain a ledger of hash values for posts, and compare the ledgers when receiving a new post to verify that the new post is authentic. This is a known principle of blockchain and is rooted in distributed ledger technology. The application of these principles to posts in social media is an innovative improvement over conventional techniques.

At Step S255, the app computer device 200 hashes the data received from each of friends. The data that is hashed includes, for example, the metadata of the post, which will be used as an identifier of the post once hashed. The metadata of the post includes, for example, a hash value of the data (i.e., content) of the post, a hash value of the prior post, a creation and/or modification time of the post, the type of post, etc. As a result of hashing the received data related to the post of each friend, for each friend's post, the app computer device 200 has (i) a hash value of the metadata of the post, which is received from the hub computer 100 as discussed in more detail below, (ii) the metadata, (iii) a hash value of the content of the friend's post received from the friend, and (iv) the data/content of the friend's post.

At Step S256, the app computer device 200 computes the resulting hash value obtained when hashing the data in Step S255. In other words, the app computer device 200 hashes a combination of the metadata of the friend's post ((ii) above) and the hash value of the content of the friend's post received from the friend ((iii) above).

At Step S257, the app computer device 200 verifies that post received from the friend is authentic. The verification is performed by (1) confirming that the hash value of the content of the friend's post matches the hash value of the content of the friend's post received from the friend; and (2) confirming that the hash value determined in Step S256 matches the hash value of the friend's post received from the hub computer 100. Upon satisfying both (1) and (2) above, the post from the friend is verified as authentic, and the process proceeds to Step S258.

At Step S258, the app computer device 200 displays the verified post(s) from the friends on the Friends List to the user of the app computer device 200.

### Hub Computer 100

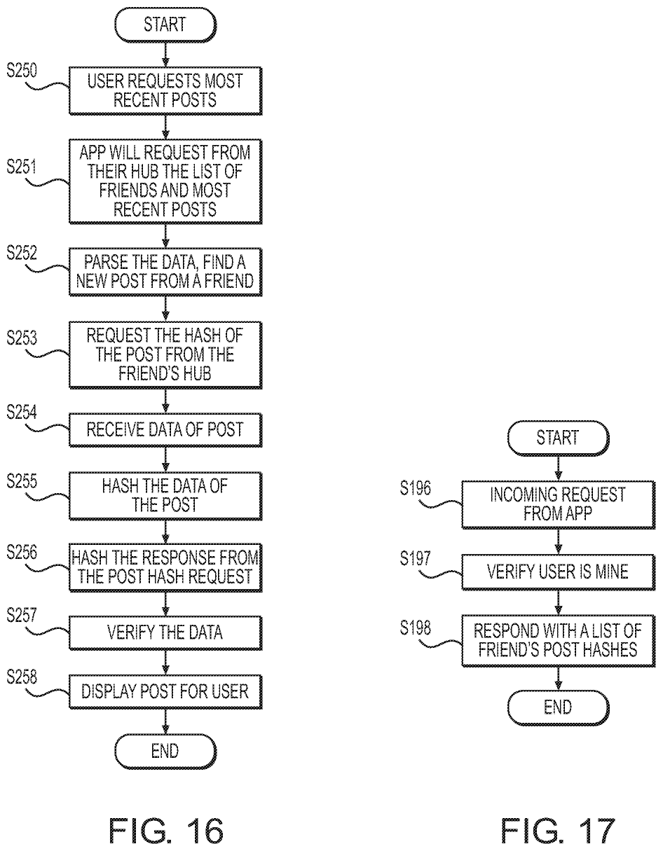

As shown in FIG. 17, at Step S196, the hub computer 100 receives a request from the app computer device 200 to acquire a current version of the Friends List and all new or most recent posts from the friends on the Friends List. At Step S197, the hub computer 100 establishes a secure connection with the app computer device 200 to verify that the user requesting the Friends List is authentic.

At Step S198, the hub computer 100 acquires the current version of the Friends List and corresponding hash values of most recent posts received from the friends on the Friends List. The hub computer 100 then transmits the Friends List and the hash values to the app computer device 200.

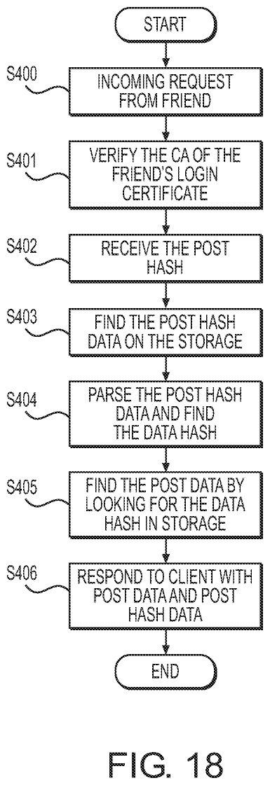

As shown in FIG. 18, the hub computer of any one of the friends on the Friends List may perform the following processes when receiving a request for a post of the friend from the app computer device 200 of the user. At Step S400, the hub computer of the friend (friend's hub computer) receives the incoming request from the app computer device 200 for a post of the friend. At Step S401, the friend's hub computer verifies and authenticates the user of the app computer device 200 by verifying that the Certificate Authority of the Login Certificate of the friend, which is received from the app computer device 200 with the request for the post of the friend.

Upon verifying the user of the app computer device 200, at Step S402, the friend's hub computer receives the hash value of the post from the app computer device, which obtained the hash value from the hub computer 100. At Step S403, the friend's hub computer searches for hash data of the post in a storage in a memory of the friend's hub computer. At Step S404, the friend's hub computer parses the hash data of the post in the storage and acquires/extracts the hash of the data of the post using the hash data.

At Step S405, the friend's hub computer finds the post and the data of the post by using the hash of the data of the post and searching the storage to locate the post (and the data of the post). At Step S406, the friend's hub computer transmits the post, the data of the post, and the hash data of the post to the app computer device 200. By performing these processes the user and the friends on the network are able to maintain an up-to-date record of the shared data/posts of all of the users, which is also used for security to perform self-authentication between the user and each of the friends on the Friends List.

The above-described processes are examples of the devices and processes that may be implemented to achieve the improvements of the exemplary embodiments. The above processes are not limited to the description herein and may include more processes or may be performed by omitting certain processes.

In addition, although the above-described processes of the hub computer 100 and the app computer device 200 are described as being performed on each separate device, an alternative embodiment performs all of the processes of the hub computer 100 and the app computer device 200 on the same computer device. In other words, the hub computer 100 and the app computer device 200 may be one computer device that includes processing hardware and memory configured to perform all of the above-mentioned processes related to the hub computer 100 and the app computer device 200.

The above-mentioned devices are computational devices formed of processing structure, such as, but not limited to, a central processing unit (CPU) or processor, ASICS, control unit, and any equivalent processing structure. The computational devices may also be formed of memory structure, such as, but not limited to, RAM, ROM, removable memory devices, etc.

The above-mentioned processes are implemented to provide an improved network, specifically a social media network, in which users structure a secure decentralized network that is easy for users to setup and operate without the continued monitoring dependence on a central server. The exemplary embodiments provide that the hub computer for each user generates its own Certificate Signing Request (CSR) and a corresponding private key, and send the CSR to the cloud server to perform signing of a certificate. The signed certificate (SSL certificate) is then used by the app on the user's computer device to establish a secure connection. A similar principle is then applied to authenticating the identity of each user for the different operations requiring secure connections to the other devices on the network. The Login certificate authority (CA) is used to sign login certificates and to verify signed certificates, which are used to verify or authenticate users.

In addition, the network implements hashing to reduce the file size of information shared over the network and the amount of information that must be shared between devices on the network in order to obtain security and authenticate information. The functionality of the network is improved by reducing the amount of information that is required to be transferred between devices on the network. The storage capacity or requirements of each of the devices may be more efficiently used or reduced by reducing the amount of data that must be used for authentication and security. By implementing hashing of data, the values of the hash serve to minimize the amount of data necessary to provide security and authentication.

In order words, instead of storing the entire certificate in the app computer device for each hub computer, the app computer device only needs to store the hash value of the certificate, which is comparatively negligible in size. Newer processors have built in hardware on the IC chips that allow for extremely fast and efficient hashing. By using this hashing technique, and then comparing the hash values, the network has added security when connecting to hub computers. This also ensures that a third party cannot intercept the connection, which makes the connection additionally secure.

1. A method performing an initial login procedure for a network, the method comprising:
generating, by a hub computer, a certificate signing request and a corresponding private key for each of a hub certificate and a login certificate;
signing, by a hub computer, the certificate signing request of the login certificate with a generated self-signed login certificate authority, and generating a combined file of the login certificate authority and the private key;
initiating, by a hub computer, a secure server using the login certificate authority, and transmitting a request for a new login to a cloud server;
generating, at the cloud server, a signed certificate, and transmitting the signed certificate to the hub computer;
connecting, by an app computer device, to the hub computer, and receiving the signed certificate from the hub computer;
hashing the received signed certificate to obtain a hash value, and verifying the hash value using a hash value of the signed certificate from the cloud server; and
transmitting, from the app computer device, a request for login to the hub computer, and receiving the login certificate from the hub computer to login.

2. The method according to claim 1, further comprising:
stopping, by the hub computer, listening for new connections using the login certificate authority; and
initiating, by the hub computer, listening for new connections with the app computer device 200 using the signed certificate received from the cloud server 300.

3. The method according to claim 1, further comprising storing the signed certificate and the login certificate, by the cloud server, with data of the hub computer, the data of the hub computer including an internet protocol address and a port of the hub computer, a hub name, a hash value of a secret generated by the hub computer, and a hash value of the signed certificate.

4. The method according to claim 1, further comprising:
verifying the hash value is performed by comparing, by the app computer device, the hash value of the signed certificate received from the cloud server and the hash value of the signed certificate obtained by the hashing of the signed certificate;
when the hash value received from the cloud server matches the hash value of the signed certificate obtained by the hashing of the signed certificate, transmitting, by the app computer device, an inputted secret displayed to the user at the hub computer to the hub computer as a part of a request for login to the hub computer; and
receiving, by the app computer device, the login certificate and private key to establish the login.

5. A method of connecting with users on a network, the method comprising:
establishing, by an app computer device, a secure connection between the app computer device and a hub computer over the network;
hashing, by the app computer device, a signed certificate retrieved from the hub computer, and verifying a hash value of the signed certificate;
transmitting, by the app computer device, a login certificate to the hub computer;
requesting, by the hub computer, a hash value of a hub certificate of a friend user and a corresponding port from a cloud server;
connecting, by the hub computer, to a friend hub computer using the port from the cloud server, and generating a second hash value of the hub certificate of the friend hub computer;
confirming, by the hub computer, that the hash value of the hub certificate of the friend user received from the cloud server matches the second hash value; and
transmitting, by the hub computer, a login certificate to the friend hub computer to gain access to posts by the friend stored on the friend hub computer.

6. The method of claim 5, further comprising:
receiving, by the hub computer, the login certificate from the app computer device;
verifying the received login certificate by determining whether the login certificate is signed by a login certificate authority generated by the hub computer;
upon verifying the login certificate, parsing, by the hub computer, a hub name of the friend hub computer, and transmitting a request to the cloud server for a login certificate authority of the friend user; and
storing, by the hub computer, the login certificate authority of the friend user as a trusted certificate authority.

7. The method of claim 5, further comprising:
terminating, by the hub computer, a current server session, and starting a server session using trusted certificate authorities; and
requesting and storing, by the hub computer from the cloud server, the hash value of the hub certificate of the friend user, and a port of the hub computer of the friend on the hub computer.

8. The method of claim 5, further comprising:
upon adding the friend user, transmitting, by the hub computer, a post of a user of the hub computer and the app computer device;
receiving, by the hub computer from the friend user, a post from the friend user; and
storing, by the hub computer, the received post from the friend user.

9. The method of claim 5, wherein verifying the hash value of the signed certificate is performed by comparing, by the app computer device, the hash value of the retrieved signed certificate to the hash value received from the cloud server, and when the hash values match, the signed certificate is authenticated.

10. A method of accessing posts of another user on a network, the method comprising:
transmitting, by an app computer device of a user, a request to a hub computer of the user to acquire a new post from a friend user from a friends list of the user;
transmitting, by the app computer device, a request to a friend hub computer of the friend user;
receiving, by the app computer device from the friend hub computer, a response including the new post of the friend; and
providing the new post to the user of the app computer device.

11. The method of claim 10, further comprising:
hashing, by the app computer device, metadata of the new post; and
authenticating, by the app computer device, the new post by comparing a hash value of the metadata to a hash value of the new post received from the hub computer; and

12. The method of claim 11, wherein:
the response of the new post includes data of the new post and a hash value of the data of the new post, and
the metadata of the post includes the prior post, a creation time, and a type of the post.

13. The method of claim 11, further comprising hashing, by the app computer device, content of the new post to determine a hash value of the content of the new post,
wherein the authenticating of the new post is further performed by confirming that the hash value of the content of the new post matches a hash value of the content of the new post, which was received from the friend.

14. The method of claim 10, wherein the response from the friend hub computer includes metadata of the new post and a prior hash value of an immediately prior post.

15. The method of claim 10, wherein providing the new post is performed by displaying the new post on a display of the app computer device.
